(19) United States
(12) Patent Application Publication
(10) Pub. No.: US 2017/0268765 A1
(43) Pub. Date: Sep. 21, 2017

(54) LAMP CAPABLE OF ISOLATING HEAT SOURCE

(71) Applicant: YU LUO, SHENZHEN (CN)

(72) Inventor: YU LUO, SHENZHEN (CN)

(21) Appl. No.: 15/071,362

(22) Filed: Mar. 16, 2016

(51) Int. Cl. F21V 29/77; F21K 9/232

(52) U.S. Cl. CPC F21V 29/777; F21K 9/232; F21Y 2115/10

(57) ABSTRACT

The present invention relates to a lamp capable of isolating heat source, which comprises a lamp head and a lamp body. The lamp head includes a driver. The lamp body includes a plurality of light-emitting members. The lamp head and the lamp body are spaced by a distance. The driver and the plurality of light-emitting members are connected electrically. A gap is located between the driver and the plurality of light-emitting members according to the present invention. By taking advantage of air being thermally insulating, the thermal conduction between the driver and the plurality of light-emitting members may be blocked. Then the driver will be free from the influence of the heat generated by the plurality of light-emitting members and its operating temperature may be kept normal. Thereby, the lifetime of the lamp may be extended.

### FIELD OF THE INVENTION

The present invention relates generally to a lamp, and particularly to a lamp capable of isolating heat source.

### BACKGROUND OF THE INVENTION

A lamp is one of major inventions by humans. It brings significant convenience for people's lives. As technologies progress, there are various models of commercial lamps. Each kind of light source owns its advantages. Including incandescent lamps, fluorescent lamps, halogen lamps, electrodeless fluorescent lamps, mercury-free fluorescent lamps, and lighting light-emitting diodes (LEDs), lamps have their characteristic optoelectronic, safety, and environmental protective properties and cost-to-performance ratios. LEDs own potential advantages in lighting applications, making their adoption and market share expand rapidly.

As lighting technologies develop, the evaluation for future lighting sources is not confined to the scope of lighting efficiency. The lighting effects, comfort, biological effects, safety, environment protective properties, and resource consumption are stressed as well.

Thanks to their advantages of low power consumption and long lifetime, LEDs have been replacing gradually current incandescent lamp and power-saving lamps in the market. The related products of LEDs are also developing prosperously.

According to the prior art, as an LED is in use, the LED chip emits light with a substantial amount of accompanying heat. The heat generated by the LED chip will be conducted to the housing of the lamp structure. By using the housing of the lamp structure, the heat can be dissipated. The normal operating temperature of an LED chip is around 75 to 85 degrees. Nonetheless, the normal operating temperature of the driver is between 50 and 60 degrees approximately. The normal operating temperature of the driver is lower than that of the LED chip. Thereby, when an LED chip is in use, the temperature of the LED chip is higher than that of the driver, making the heat conducted to the driver and raising the overall temperature of the driver, which, in turn, lowers the operating efficiency of the driver. Besides, the lifetime of the lamp structure of the LED chip will be shortened as well.

The heat generated by an LED lamp structure will affect the driver. Accordingly, the present invention provides a lamp structure capable of isolating heat source to solve the drawback encountered in the prior art.

### SUMMARY

An objective of the present invention is to provide a lamp capable of isolating heat source. The lamp head and the head body are spaced by a distance. By using air, the heat conduction between the light-emitting member and the driver is isolated.

Another objective of the present invention is to provide a lamp capable of isolating heat source. The lamp head and the head body are spaced by a distance. The high-temperature air within the distance is exchanged with external low-temperature air by convection and thus improving the heat dissipating effect.

The lamp capable of isolating heat source according to the present invention comprises a lamp head and a lamp body. The lamp heat includes a housing and a driver. The housing includes an accommodating space. The driver is disposed in the accommodating space. The lamp body includes a heat dissipating structure and a plurality of light-emitting members. The plurality of light-emitting members are disposed o the surface of the heat dissipating structure. The lamp head and the lamp body are spaced by a distance. The driver and the plurality of light-emitting members are connected electrically.

According to an embodiment of the present invention, a plurality of pillars are disclosed and disposed between the lamp head and the lamp body.

According to an embodiment, a connecting tube is disclosed and disposed between the lamp head and the lamp body. The connecting tube includes a penetrating hole. The driver and the plurality of light-emitting member are connected electrically through the penetrating hole.

According to an embodiment of the present invention, the disclosed heat dissipating structure includes a body and a plurality of support members. One side of the plurality of support members are disposed annularly surrounding the body and spaced by an air channel. The other side of the plurality of support members includes a plurality of side accommodating grooves, respectively. The plurality of light-emitting members are disposed in the plurality of side accommodating grooves.

According to an embodiment of the present invention, the disclosed heat dissipating structure further includes a plurality of heat dissipating fins disposed on both sides of the support member, respectively.

According to an embodiment of the present invention, the disclosed heat dissipating structure further includes a plurality of side lamp hoods and a plurality of heat sinks. The plurality of side lamp hoods are disposed at the plurality of side accommodating grooves and covering the plurality of light-emitting members. A pair of the heat sinks are disposed on both sides of the support members, respectively, and located on both sides of each side lamp hood.

According to an embodiment of the present invention, the disclosed heat dissipating structure further includes a body and a heat dissipating plate. The dissipating plate is disposed on the top surface of the body. The heat dissipating plate includes a plate. The plate includes a top accommodating groove. The plurality of light-emitting members are disposed in the top accommodating groove.

According to an embodiment of the present invention, the disclosed heat dissipating plate further includes a top lamp hood and a plurality of top heat sinks. The top lamp hood is disposed at the top accommodating groove and covering the plurality of light-emitting members. The plurality of top heat sinks surround the plate and located on the periphery of the top lamp hood.

### BRIEF DESCRIPTION OF THE DRAWINGS

FIG. 1 shows a side view of the lamp capable of isolating heat source according to an embodiment of the present invention;

FIG. 2 shows an exploded view of the lamp capable of isolating heat source according to an embodiment of the present invention;

FIG. 3 shows another exploded view of the lamp capable of isolating heat source according to an embodiment of the present invention; and

FIG. 4 shows an exploded view and an enlarged view of the lamp body of the lamp capable of isolating heat source according to an embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

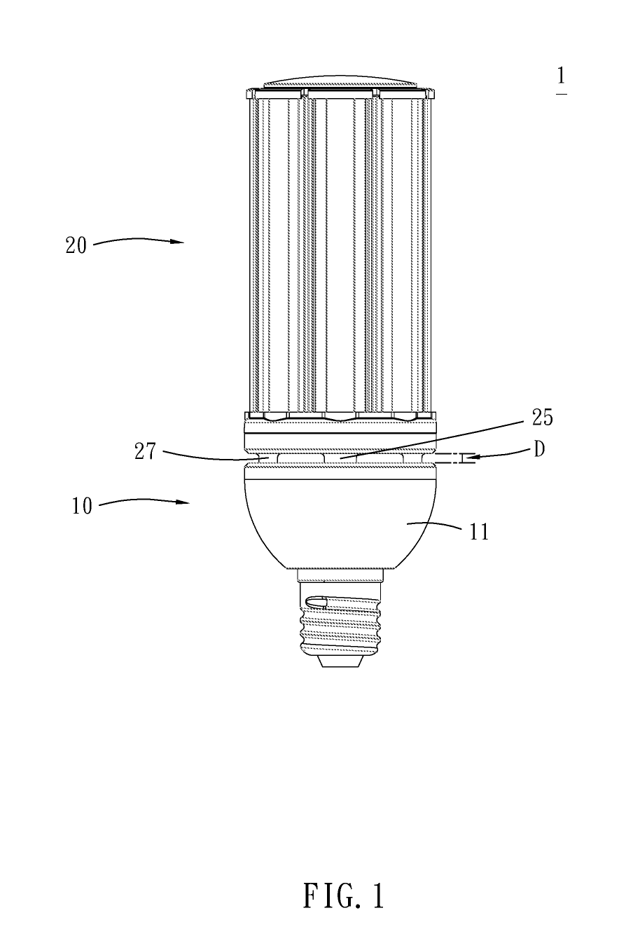

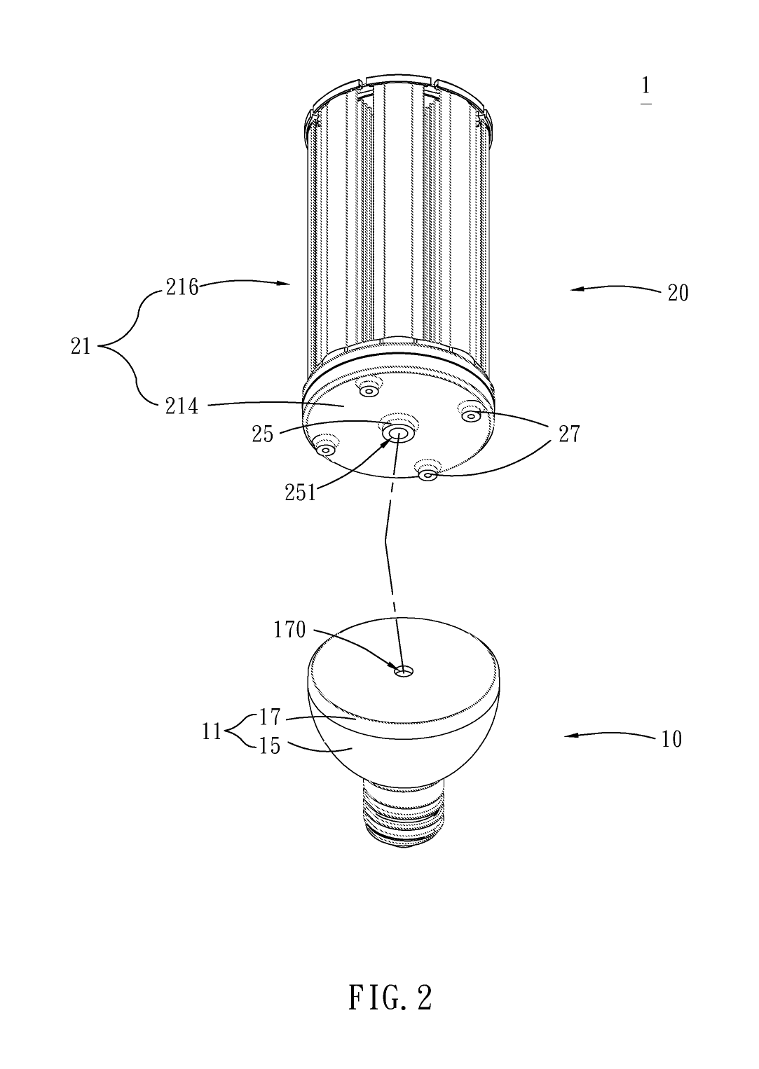

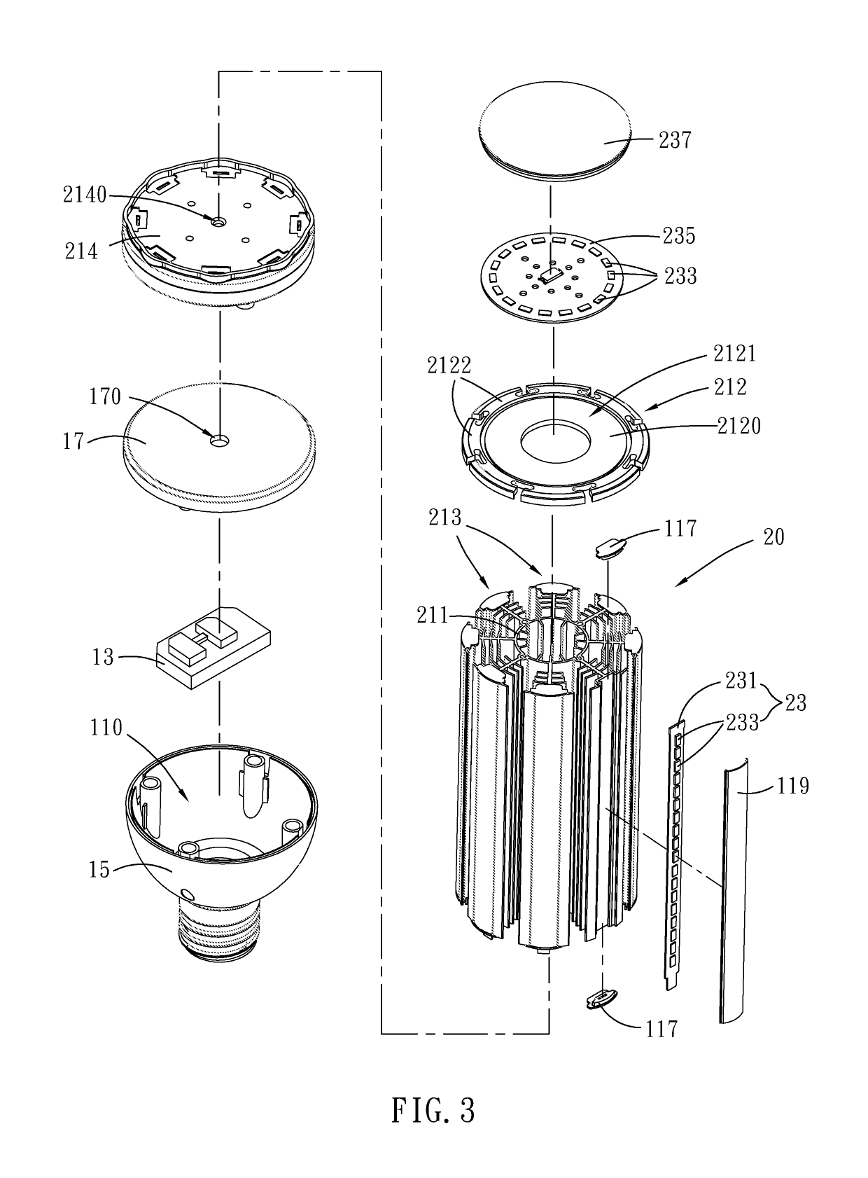

Please refer to FIGS. 1 to 3, which show a side view, an exploded view, and another exploded view of the lamp capable of isolating heat source according to an embodiment of the present invention. As shown in the figures, the lamp 1 capable of isolating heat source according to the present embodiment comprises a lamp head 10 and a lamp body 20. The lamp head 10 includes a housing 11 and a driver 13. The housing 11 includes an accommodating space 110. The driver 13 is disposed in the accommodating space 110. The lamp body 20 includes a heat dissipating structure 21 and a plurality of light-emitting members 23. The plurality of light-emitting members 23 are disposed on the surface of the heat dissipating structure 21. The lamp head 10 and the lamp body 20 are spaced by a distance D. The driver 13 and the plurality of light-emitting members 23 are connected electrically. According to the present embodiment, the lamp head 10 and the lamp body 20 are spaced. The gap is exposed to the external air. The air in the gap convects with the external air. In addition, the air in the gap may block the heat conduction between the driver 13 and the plurality of light-emitting members 23 and reduce the influence of the heat by the plurality of light-emitting members 23 on the driver 13. Thereby, the driver 13 may be maintained at normal operating temperatures.

The housing 11 of the lamp head 10 further includes a bottom case 15 and a lid 17. The bottom case 15 includes an accommodating groove. The lid 17 is disposed on the housing 15 and seals the accommodating groove to form the accommodating space 110 inside the housing 11. The heat dissipating structure 21 of the lamp body 20 further includes a heat dissipating base 214 and a heat dissipating member 216. The heat dissipating member 216 is disposed on the heat dissipating base 214. A connecting tube 25 is disposed between the lid 17 of the lamp head 10 and the heat dissipating base 214 of the lamp body 20 and located at the center of the lamp head 10 and the lamp body 20. The lid 17 includes a first hole 170. The heat dissipating base 214 include a second hole 2140 corresponding to the first hole 170 of the lid 17. The connecting tube 25 includes a penetrating hole 251 connecting the first and second holes 170, 2140. Electrical connecting wires (not shown in the figures) are located between the driver 13 and the plurality of light-emitting members 23 and pass through the penetrating hole 251. Then the driver 13 and the plurality of light-emitting members 23 may be connected electrically. Moreover, a plurality of pillars 27 are disposed between the lamp head 10 and the lamp body 20 and surrounding the periphery of the connecting tube 25. The plurality of pillars 27 are used for connected the lamp head 10 and the lamp body 20 and spacing them by the distance D.

The present embodiment improves the drawbacks of the prior art. The purpose of the heat dissipating structure of the LED lamp according to the prior art is to enhance the heat dissipating effect. Consequently, the influence of the bearable temperatures of the light-emitting device and the driving device is ignored. Normally, light-emitting devices result in higher temperatures under normal operations, whereas driving devices result in lower temperatures under normal operations. If the high temperatures of light-emitting device influence the driving device, the driving device cannot be maintained at normal operating temperatures. In the long run, the lifetime of the driving device will be affected. Accordingly, the present invention provides a lamp capable of isolating heat source. A gap exists between the lamp head 10 and the lamp body 20. The air in the gap may block heat conduction between the driver 13 and the plurality of light-emitting members 23 and thus reducing the influence of the heat generated by the plurality of light-emitting members 23 on the driver 13. The heat source is hence separated and the normal operating temperature may be maintained. Besides, the gap is exposed to the external air. When the temperature of the air in this part is raised by the lamp, convection will occur with external air having lower temperatures. Accordingly, in addition to improve the lifetime of the lamp, the heat dissipating effect is enhanced as well.

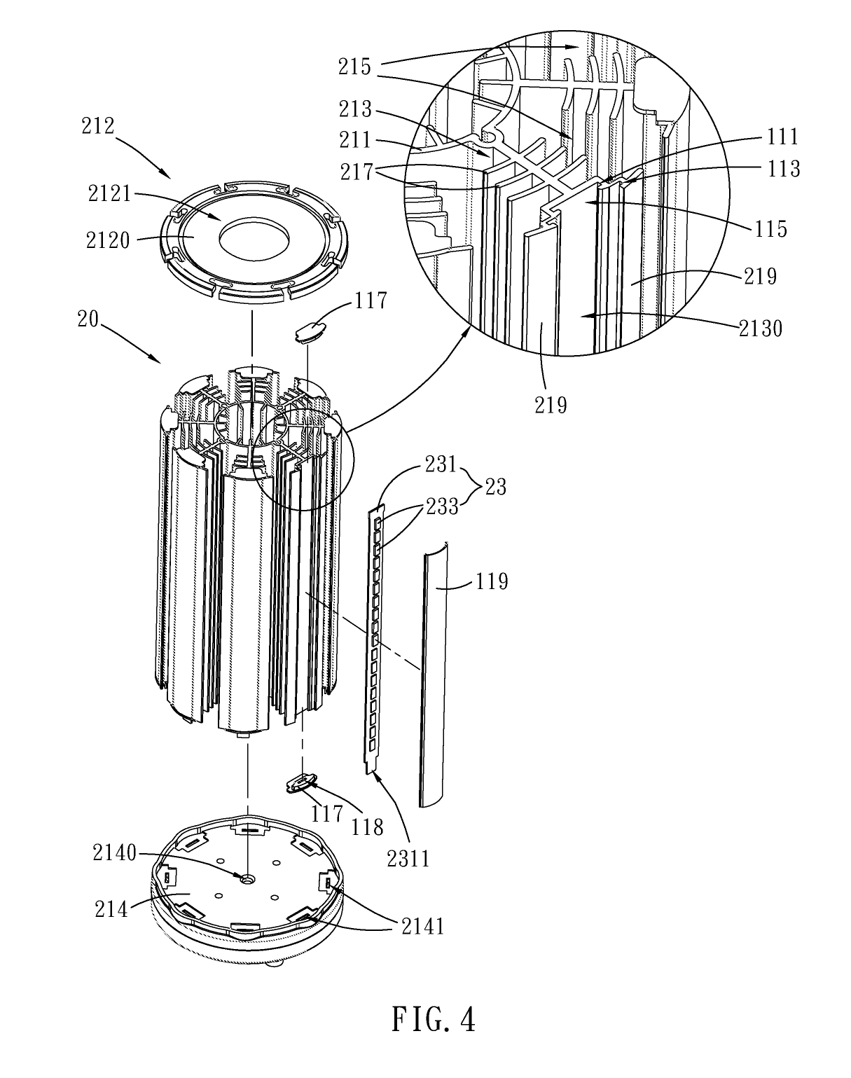

Please further refer to FIG. 4, which shows an exploded view and an enlarged view of the lamp body of the lamp capable of isolating heat source according to an embodiment of the present invention. As shown in the figure, according to the present embodiment, the heat dissipating member 216 further includes a body 211 and a plurality of support members 213. One side of the plurality of support members 213 are disposed annularly surrounding the body 211 and spaced by an air channel 215. The other side of the plurality of support members 213 includes a plurality of side accommodating grooves 2130, respectively. The plurality of light-emitting members 23 are disposed in the plurality of side accommodating grooves 2130. As the lamp is in use, the plurality of light-emitting members 23 will generate heat, which is then conducted to the plurality of support members 213 and dissipated from the surface thereof. The temperature of the air inside the plurality of air channels 215 will rise, making the air to convect with the external air having lower temperatures. Thereby, the heat dissipating effect of the lamp is improved.

According to the present embodiment, the plurality of support members 213 include eight support members 213 and the air channel 215 is located between adjacent support members 213. Nonetheless, according to the present embodiment, the number of the support members 213 is not limited. Each support member 213 includes a side accommodating groove 2130. Each said accommodating groove 2130 is a rectangular groove, which further includes a light-emitting-member inset part 111 and a lamp-hood inset part 113. The light-emitting-member inset part 111 is located at the groove bottom of the side accommodating groove 2130; the lamp-hood inset part 113 is located at the groove opening of the side accommodating groove 2130. Each of the both ends of each side accommodating groove 2130 includes an opening 115 corresponding to a lid 118, respectively.

Each light-emitting member 23 of each side accommodating groove 2130 includes a side substrate 231 and a plurality of LED chips 233. The plurality of LED chips 233 are disposed on the side substrate 231. Each light-emitting device 23 insets into the light-emitting-member inset part 111 from the opening 115 of one end of the side accommodating groove 2130. In addition, a plurality of side lamp hoods 119 inset into the lamp-hood inset part 113 correspondingly, so that the plurality of side lamp hoods 119 may be disposed in the plurality of side accommodating grooves 2130, respectively, and covering the plurality of light-emitting members 23. Furthermore, the lid 117 of heat dissipating member 216 on the side corresponding to the heat dissipating base 214 includes a hole 118. One end of the side substrate 231 corresponding to the hole 118 of the lid 117 further includes a projective part 2311 passing through the hole 118 of the lid 17. Moreover, the heat dissipating base 214 includes a plurality of inset holes 2141. The projective part 2311 of the side substrate 231 further inset into the inset hole 2141 after passing through the hole 118. Thereby, the combination of the heat dissipating member 216 and the heat dissipating base 214 may be firmer.

The heat dissipating structure 21 further includes a plurality of heat dissipating fins 217 disposed on both sides of the support member 213, respectively, and located in the plurality of air channels 215. Thereby, the heat-dissipating surface area of each support member 213 is increased and hence enhancing the heat dissipating effect. Besides, the heat dissipating structure 21 further includes a plurality of heat sinks 219. Two heat sinks 219 are disposed on both sides of the other side of each support member 213, respectively, and located on both sides of each side lamp hood 119. Because the heat sinks 219 are located on both outer sides of the plurality of side accommodating grooves 2130 and close to the light-emitting member 23, further conductive heat dissipation from the plurality of light-emitting members 23 may be provided.

According to the present embodiment, the heat dissipating structure further includes a heat dissipating plate 212 disposed on the top surface of the body 211. The heat dissipating plate 212 includes a plate 2120. The plate 2120 includes a top accommodating groove 2121. The plurality of light-emitting members 23 are disposed in the top accommodating groove 2121. The plurality of light-emitting members 23 include a top substrate 235 and a plurality of LEDs 233. The plurality of LEDs 233 are disposed on the top substrate 235. The top substrate 235 insets into the top accommodating groove 2121. In addition, a top lamp hood 237 is disposed on the top accommodating groove 2121 and covering the plurality of light-emitting members 23. The heat dissipating plate 212 further includes a plurality of top heat sinks 2122 surrounding the plate 2120 and located on the periphery of the top lamp hood 237. Accordingly, the overall heat-dissipating surface of the light-emitting members 23 may be increased by using the plurality of top heat sinks 2122 on the periphery of the plate 2120 and the heat dissipating effect may be enhanced.

To sum up, the lamp capable of isolating heat source comprises a lamp head and a lamp body. The lamp head includes a driver. The lamp body includes a plurality of light-emitting members. The lamp head and the lamp body are spaced by a distance. The driver and the plurality of light-emitting members are connected electrically. A gap is located between the driver and the plurality of light-emitting members according to the present invention. By taking advantage of air being thermally insulating, the thermal conduction between the driver and the plurality of light-emitting members may be blocked. Then the driver will be free from the influence of the heat generated by the plurality of light-emitting members and its operating temperature may be kept normal. Thereby, the lifetime of the lamp may be extended. In addition, the gap may facilitate air convection with the exterior. Hence, heat may be dissipated by using the convection of the external cold air and the hot air in the gap.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

What is claimed is:

1. A lamp capable of isolating heat source, comprising:
a lamp head, having a housing and a driver, said housing having an accommodating groove, and said driver disposed in said accommodating groove; and
a lamp body, having a heat dissipating structure and a plurality of light-emitting members, said plurality of light-emitting members disposed on the surface of said heat dissipating structure, said lamp head and said lamp body spaced by a distance, and said driver and said plurality of light-emitting members connected electrically.

2. The lamp capable of isolating heat source of claim 1, further comprising a plurality of pillars disposed between said lamp head and said lamp body.

3. The lamp capable of isolating heat source of claim 1, further comprising a connecting tube, disposed between said lamp head and said lamp body, having a penetrating hole, and said driver and said plurality of light-emitting members connected electrically through said penetrating hole.

4. The lamp capable of isolating heat source of claim 1, wherein said heat dissipating structure includes:
a body; and
a plurality of support members, one side of said plurality of support members disposed annularly surrounding said body and spaced by an air channel, the other side of said plurality of support members including a plurality of side accommodating grooves, respectively, and said plurality of light-emitting members disposed in said plurality of side accommodating grooves.

5. The lamp capable of isolating heat source of claim 4, wherein said heat dissipating structure further includes a plurality of heat dissipating fins disposed on both sides of said support member.

6. The lamp capable of isolating heat source of claim 4, wherein said heat dissipating structure further includes:
a plurality of side lamp hoods, disposed at said plurality of side accommodating grooves, respectively, and covering said plurality of light-emitting members; and
a plurality of heat sinks, each pair of said heat sinks disposed on both sides of said support members, respectively, and located on both sides of each said side lamp hood.

7. The lamp capable of isolating heat source of claim 1, wherein said heat dissipating structure includes:
a body; and
a heat dissipating plate, disposed on the top surface of said body, having a plate, said plate having a top accommodating groove, and said plurality of light-emitting members disposed in said top accommodating groove.

8. The lamp capable of isolating heat source of claim 7, wherein said heat dissipating plate further includes:
a top lamp hood, disposed at said top accommodating groove, and covering said plurality of light-emitting members; and
a plurality of top heat sinks, surrounding said plate, and located on the periphery of said top lamp hood.
